(19) United States
(12) Patent Application Publication
(10) Pub. No.: US 2018/0103430 A1
(43) Pub. Date: Apr. 12, 2018

(54) ACCESS POINT DISCOVERY USING A WAKEUP RECEIVER

(71) Applicant: QUALCOMM Incorporated, San Diego, CA (US)

(72) Inventors: Linhai HE, San Diego, CA (US); Stephen Jay SHELLHAMMER, Ramona, CA (US); Santosh Paul ABRAHAM, San Diego, CA (US); Bin TIAN, San Diego, CA (US)

(21) Appl. No.: 15/681,259

(22) Filed: Aug. 18, 2017

Related U.S. Application Data
(60) Provisional application No. 62/406,283, filed on Oct. 10, 2016.

(51) Int. Cl. H04W 52/02; H04W 48/16

(52) U.S. Cl. CPC H04W 52/0235; H04W 84/12; H04W 52/0216; H04W 48/16

(57) ABSTRACT

A method of operation of an electronic device includes receiving a discovery message from an access point using a wakeup receiver of the electronic device. The method further includes activating a modem of the electronic device in response to receiving the discovery message. Operation of the wakeup receiver is associated with a first power consumption that is less than a second power consumption associated with operation of the modem. The method further includes performing an association process with the access point using the modem after activating the modem.

### I. CROSS REFERENCE TO RELATED APPLICATIONS

The present application claims the benefit of U.S. Provisional Patent Application No. 62/406,283, entitled “ACCESS POINT DISCOVERY USING A WAKEUP RECEIVER,” filed Oct. 10, 2016, which is expressly incorporated by reference herein in its entirety.

### II. FIELD

The present disclosure is generally related to electronic devices and more particularly to access point discovery for electronic devices.

### III. DESCRIPTION OF RELATED ART

A station (e.g., a mobile device) may communicate with an access point using a wireless network, such as a wireless local area network (WLAN). For example, a mobile device may send data to the access point using the wireless network. As another example, the mobile device may receive data from the access point using the wireless network.

To detect an access point, a station may search one or more channels of the wireless network to receive a beacon sent by the access point. Searching for beacons results in power consumption by the station. For example, the station may tune to a plurality of different channels at different times to detect a beacon. Tuning to different channels results in power consumption by the station, which reduces battery life of the station.

### IV. SUMMARY

An electronic device in accordance with the disclosure receives a discovery message (e.g., a beacon) from an access point using a wakeup receiver. Upon receiving the discovery message using the wakeup receiver, the electronic device may power-up or activate a modem (e.g., to enable association with the access point using the modem, such as using a Wi-Fi communication technique). In an illustrative example, the modem is in a low-power state (e.g., a deactivated state) when the discovery message is received using the wakeup receiver.

Use of the wakeup receiver reduces power consumption by the electronic device. To illustrate, operation of the wakeup receiver may result in less power consumption (e.g., due to a narrowband operation characteristic of the wakeup receiver) as compared to operation of the modem. As a result, use of the wakeup receiver to detect the discovery message reduces power consumption of the electronic device by enabling the electronic device to operate the modem in a low-power state.

In an illustrative example, a method of operation of an electronic device includes receiving a discovery message from an access point using a wakeup receiver of the electronic device. The method further includes activating a modem of the electronic device in response to receiving the discovery message. The method may further include communicating with the access point using the modem. Operation of the wakeup receiver is associated with a first power consumption that is less than a second power consumption associated with operation of the modem. The method further includes performing an association process with the access point using the modem after activating the modem.

In another illustrative example, an apparatus includes a wakeup receiver configured to receive a discovery message from an access point. The apparatus further includes control circuitry coupled to the wakeup receiver and a modem coupled to the control circuitry. The control circuitry is configured to generate a wakeup signal based on the discovery message. The modem is configured to receive the wakeup signal and to perform an association process with the access point in response to the wakeup signal.

In another illustrative example, an apparatus includes means for receiving a discovery message from an access point. The apparatus further includes means for generating a wakeup signal based on the discovery message and means for performing an association process with the access point in response to the wakeup signal. Operation of the means for receiving the discovery message is associated with a first power consumption that is less than a second power consumption associated with operation of the means for performing the association process.

In another illustrative example, a computer-readable medium stores instructions executable by a processor to initiate or control operations. The operations include receiving a discovery message from an access point using a wakeup receiver of an electronic device. The operations further include activating, in response to receiving the discovery message, a modem of the electronic device. Operation of the wakeup receiver is associated with a first power consumption that is less than a second power consumption associated with operation of the modem. The operations further include performing an association process with the access point using the modem after activating the modem.

One particular advantage provided by at least one of the disclosed examples is reduced power consumption by an electronic device. For example, use of a wakeup receiver to detect one or more discovery messages reduces power consumption as compared to searching for discovery messages using a modem. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of an illustrative example of a system that includes an access point configured to send a discovery message using a wakeup transmitter and an electronic device configured to receive the discovery message using a wakeup receiver.

FIG. 2 is a diagram of an illustrative example of a wakeup radio (WUR) frame format that may be associated with the discovery message of FIG. 1 and an example of a channel assignment scheme that may be used by the system of FIG. 1.

FIG. 3 is a flow chart of a method of operation of an electronic device, such as the electronic device of FIG. 1.

FIG. 4 is a flow chart of a method of operation of an access point, such as the access point of FIG. 1.

FIG. 5 is a block diagram of an illustrative example of an electronic device, such as the electronic device of FIG. 1.

### VI. DETAILED DESCRIPTION

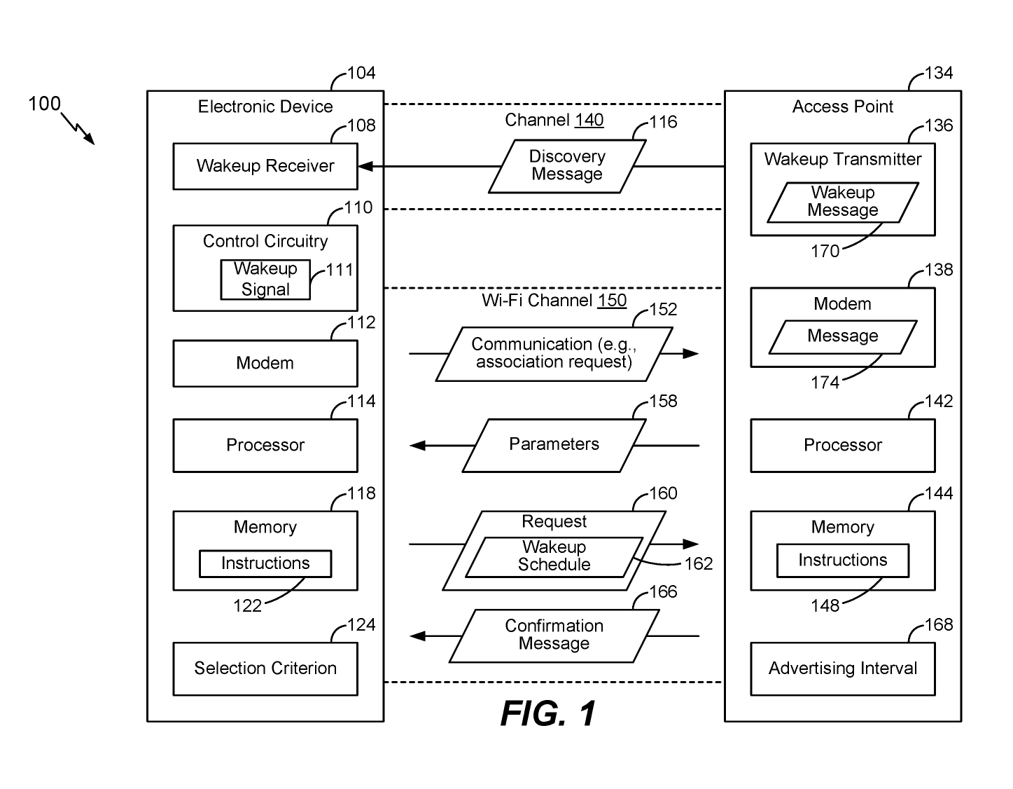

FIG. 1 depicts an illustrative example of a system 100. The system 100 includes an electronic device 104 and an access point 134. The electronic device 104 may correspond to a station (STA), such as a mobile device, as an illustrative example. In other examples, the electronic device 104 may correspond to another device, such as an Internet-of-things (IOT) device, as an illustrative example.

The electronic device 104 includes a wakeup receiver 108, control circuitry 110, and one or more radio devices configured to operate based on an Institute of Electrical and Electronics Engineers (IEEE) 802.11 (“Wi-Fi”) communication protocol. For example, the radio device may include a modem 112. The modem 112 may be configured to operate based on one or more IEEE 802.11 communication protocols, such as a Wi-Fi communication protocol. The control circuitry 110 is coupled to the wakeup receiver 108, and the modem 112 is coupled to the control circuitry 110.

Operation of the wakeup receiver 108 is associated with a first power consumption that is less than a second power consumption associated with operation of the modem 112. To illustrate, the wakeup receiver 108 is configured to receive messages (e.g., from an access point, such as the access point 134) using less power as compared to power used by the modem 112 to receive messages (e.g., from the access point 134). For example, the wakeup receiver 108 may have a narrowband configuration. In this case, the wakeup receiver 108 is configured to receive messages using a frequency band having a first bandwidth that is less than a second bandwidth of a frequency band used by the modem 112 to receive messages. The wakeup receiver 108 may be configured to receive signals having a unique physical waveform corresponding to the wakeup receiver 108 (e.g., as compared to waveforms associated with other receivers). In a particular example, the wakeup receiver 108 is configured to receive messages using a reduced data rate as compared to a data rate used to send messages received by the modem 112. In this example, the unique physical waveform may be associated with a data rate that is less than data rates associated with certain other waveforms. Alternatively or in addition, the wakeup receiver 108 may be configured to operate with functionality specialized for receiving the unique physical waveform at very low power, which may reduce power consumption as compared to receiving a signal using a transceiver having “full” transceiver functionality. To further illustrate, the wakeup receiver 108 may correspond to a “standalone” receiver, where the electronic device 104 does not include a corresponding transmitter associated with the wakeup receiver 108 (which may reduce power consumption as compared to a “full” transceiver).

Receiving messages using the first bandwidth may result in reduced power consumption by the electronic device 104 as compared to receiving messages using the second bandwidth. To illustrate, signals transmitted using the first bandwidth may be associated with reduced noise (e.g., reduced thermal noise) as compared to signals transmitted using the second bandwidth, resulting in increased signal-to-noise ratios (SNRs) of the signals transmitted using the first bandwidth. Increased SNRs may enable reduced amplification to send and receive the signals, reducing power consumption by the electronic device 104.

The electronic device 104 further includes a processor 114 and a memory 118. The memory 118 stores instructions 122. The processor 114 is coupled to the memory 118 and is configured to access the instructions 122. The processor 114 is configured to execute the instructions 122 to initiate, control, or perform one or more operations described herein.

The access point 134 includes the wakeup transmitter 136 and a modem 138. The wakeup transmitter 136 may be configured to send messages (e.g., to an electronic device, such as the electronic device 104) using a first power consumption that is less than a second power consumption used by the modem 138 to send messages. For example, the wakeup transmitter 136 may have a narrowband configuration. In this case, the wakeup transmitter 136 may be configured to send messages using a frequency band having a first bandwidth that is less than a second bandwidth of a frequency band used by the modem 138 to send messages. To further illustrate, the second power consumption may be at least 10 times or at least 100 times greater than the first power consumption, as non-limiting illustrative examples.

Sending messages using the first bandwidth may result in reduced power consumption by the access point 134 as compared to sending messages using the second bandwidth. To illustrate, signals transmitted using the first bandwidth may be associated with reduced noise (e.g., reduced thermal noise) as compared to signals transmitted using the second bandwidth, resulting in increased SNRs of the signals transmitted using the first bandwidth. Increased SNRs may enable reduced amplification to send and receive the signals, reducing power consumption by the access point 134.

The access point 134 further includes a processor 142 and a memory 144. The memory 144 stores instructions 148. The processor 142 is coupled to the memory 144 and is configured to access the instructions 148. The processor 142 is configured to execute the instructions 148 to initiate, control, or perform one or more operations described herein.

One or more of the wakeup receiver 108, the modem 112, the wakeup transmitter 136, and the modem 138 may be configured to operate using one or more wireless communication protocols. As an illustrative example, one or more of the wakeup receiver 108, the modem 112, the wakeup transmitter 136, and the modem 138 may be configured to operate in compliance with one or more IEEE 802.11 wireless communication protocols.

During operation, the access point 134 may send a discovery message 116 (e.g., a beacon) using the wakeup transmitter 136. The discovery message 116 may indicate (e.g., “advertise”) one or more wireless networks associated with the access point 134, such as a wireless local area network (WLAN) associated with the access point 134. The access point 134 may send the discovery message 116 based on an advertising interval 168. The advertising interval 168 may indicate a frequency at which the access point 134 is to send the discovery message 116. In some examples, a wireless communication protocol (e.g., an IEEE 802.11 wireless communication protocol, as an illustrative example) specifies one or more of the advertising interval 168 or a time at which the discovery message 116 is to be sent, and the electronic device 104 and the access point 134 comply with the wireless communication protocol. In some implementations, the access point 134 may send the discovery message 116 more frequently as compared to discovery messages sent in certain other networks. For example, the access point 134 may be connected to a main power supply, and the access point 134 may send the discovery message 116 more frequently as compared to a battery-supplied mobile device that advertises a peer-to-peer (P2P) network.

In an illustrative example, the access point 134 is configured to send the discovery message 116 using a channel 140. The channel 140 may be associated with a particular wireless communication protocol (e.g., an IEEE 802.11 wireless communication protocol, as an illustrative example).

The electronic device 104 may perform a scanning process to detect one or more access points within communication range of the electronic device 104. For example, the electronic device 104 may tune the wakeup receiver 108 to scan one or more channels (e.g., the channel 140) that are specified by a particular wireless communication protocol (e.g., an IEEE 802.11 wireless communication protocol, as an illustrative example). In some cases, the modem 112 may operate according to a sleep mode of operation during the scanning process (e.g., if the electronic device 104 is not associated with an access point).

During the scanning process, the electronic device 104 may receive the discovery message 116 from the access point 134 using the wakeup receiver 108. In some cases, the electronic device 104 may deactivate the modem 112 prior to receiving the discovery message 116 (e.g., the electronic device 104 may receive the discovery message 116 while the modem 112 operates according to a standby mode of operation).

The electronic device 104 is configured to activate the modem 112 in response to receiving the discovery message 116. To illustrate, the control circuitry 110 is configured to generate a wakeup signal 111 based on the discovery message 116, and the modem 112 is configured to receive the wakeup signal 111. In this example, in response to receiving the discovery message 116, the electronic device 104 may provide the wakeup signal 111 (e.g., an activation signal) to the modem 112 to activate the modem 112 (e.g., to switch operation of the modem 112 from a sleep mode to an active mode). In some implementations, the electronic device 104 may include a switch configured to receive a supply voltage that powers the modem 112, and the control circuitry 110 may power-up the modem 112 by activating the switch in response to the discovery message 116.

After activating the modem 112, the electronic device 104 is configured to communicate with the access point 134 using the modem 112. For example, the electronic device 104 perform an association process with the access point 134 after activating the modem 112. Performing the association process may include sending and receiving one or more association messages using a Wi-Fi channel 150 that is included in a Wi-Fi network used by the access point 134 to communicate with the electronic device 104. The Wi-Fi channel 150 is distinct from the channel 140. As an illustrative example, the electronic device 104 may send a communication 152 (e.g., an association request) to the access point 134 based on the discovery message 116. The communication 152 may be received by the access point 134 using the Wi-Fi channel 150.

In some cases, the electronic device 104 may initiate a sleep mode of operation (e.g., during a period of communication inactivity of the electronic device 104). In some implementations, to initiate the sleep mode of operation, the electronic device 104 sends a request 160 to the access point 134. The request 160 may indicate that the electronic device 104 is to enter the sleep mode of operation. The access point 134 may provide a confirmation message 166 to the electronic device 104 in response to the request 160, and the electronic device 104 may enter the sleep mode of operation in response to the confirmation message 166.

The access point 134 may wake the electronic device 104 in response to determining that a message 174 (e.g., data) is available for the electronic device 104. For example, the access point 134 may use the wakeup transmitter 136 to send a wakeup message 170 to the wakeup receiver. In some examples, the access point 134 sends the wakeup message 170 to the electronic device 104 using the channel 140. In this case, the channel 140 may correspond to a wakeup channel that is reserved for wakeup messages. In other examples, the wakeup message 170 is sent to the electronic device 104 using a wakeup channel that is distinct from the channel 140.

In an illustrative example, performing the association process to associate the electronic device 104 and the access point 134 includes receiving parameters 158 at the electronic device 104 from the access point 134. The parameters 158 are related to a wakeup procedure performed by the electronic device 104 and the access point 134. As an illustrative example, the parameters 158 may indicate an identifier indicated by wakeup messages of the access point 134. To illustrate, the identifier may include a static address associated with the access point 134 or a dynamic address associated with the access point 134, such as a dynamic address that is drawn from (or pseudo-randomly generated based on) a sequence of identifiers known to both access point 134 and the electronic device 102. The identifier may be associated with the wakeup transmitter 136.

The electronic device 104 may use the parameters 158 in connection with the wakeup procedure. To illustrate, the electronic device 104 may use an identifier indicated by the parameters 158 to identify (or “recognize”) the access point 134 as the sender of the wakeup message 170.

In some implementations, the electronic device 104 is configured to perform a Wi-Fi scanning process in connection with searching using the wakeup receiver 108. For example, the electronic device 104 may scan the Wi-Fi channel 150 using the modem 112 to enable detection of a “legacy” access point that sends discovery messages using the Wi-Fi channel 150. In some examples, the electronic device 104 performs the scanning process using a particular search interval that is greater than a wakeup interval (e.g., an interval that is based on a wakeup schedule 162) associated with searching using the wakeup receiver 108. For example, the electronic device 104 may “prefer” to search using the modem 112 less than searching using the wakeup receiver 108. In this case, the electronic device 104 may search using the modem 112 less frequently as compared to searching using the wakeup receiver 108 in order to reduce power consumption.

In some examples, the request 160 indicates the wakeup schedule 162 associated with the electronic device 104. The wakeup schedule 162 may correspond to a length of time between scanning operations performed by the electronic device 104. For example, during a sleep mode of operation, the electronic device 104 may wake based on the wakeup schedule 162 to search for discovery messages, such as the discovery message 116.

The electronic device 104 may operate based on an active mode for a particular duration of the wakeup schedule 162 to search for the discovery message 116. At other times during the wakeup schedule 162, the electronic device 104 may remain in a low-power state. In some implementations, the electronic device 104 is configured to select one or both of the wakeup schedule 162 or the particular duration of the wakeup schedule 162. For example, the electronic device 104 may select the particular duration based on the advertising interval 168. The electronic device 104 may select the particular duration to be greater than or equal to the advertising interval 168 (e.g., to enable reception of the discovery message 116). As another example, the electronic device 104 may select the wakeup schedule 162 to enable a particular power consumption by the electronic device 104.

In some implementations, the electronic device 104 is configured to identify a selection criterion 124 based on the discovery message 116. The electronic device 104 may be configured to initiate the association process to associate with the access point 134 in response to determining that the discovery message 116 satisfies the selection criterion 124. For example, the electronic device 104 may apply the selection criterion 124 to select one or more access points that are “preferred” or “trusted” by the electronic device 104. As an illustrative example, the control circuitry 110 may be configured to store or to access a list (e.g., a “white list”) of devices, such as a home access point or a work access point. The control circuitry 110 may be configured to detect an indication included in the discovery message 116, such as a basic service set identification (BSSID) of the access point 134 or a compressed (e.g., hashed) version of the BSSID. The control circuitry 110 may be configured to provide the wakeup signal 111 to the modem 112 in response to determining that the list includes the BSSID or the compressed version of the BSSID.

Alternatively or in addition, the selection criterion 124 may specify that the electronic device 104 prefers access points associated with a particular service provider. In this case, the electronic device 104 may associate with the access point 134 in response to determining that the discovery message 116 satisfies the selection criterion 124. Alternatively, the electronic device 104 may decline to associate with the access point 134 in response to determining that the discovery message 116 fails to satisfy the selection criterion 124. Alternatively or in addition, the selection criterion may specify a particular communication protocol, a particular data communication rate or bandwidth, a modulation and coding scheme (MCS), other information, or a combination thereof.

One or more aspects of FIG. 1 may improve performance of a device, such as the electronic device 104. For example, by receiving the discovery message 116 using the wakeup receiver 108, the electronic device 104 may reduce or avoid instances of searching using the modem 112. As a result, power consumed by the electronic device 104 during a search operation may be reduced.

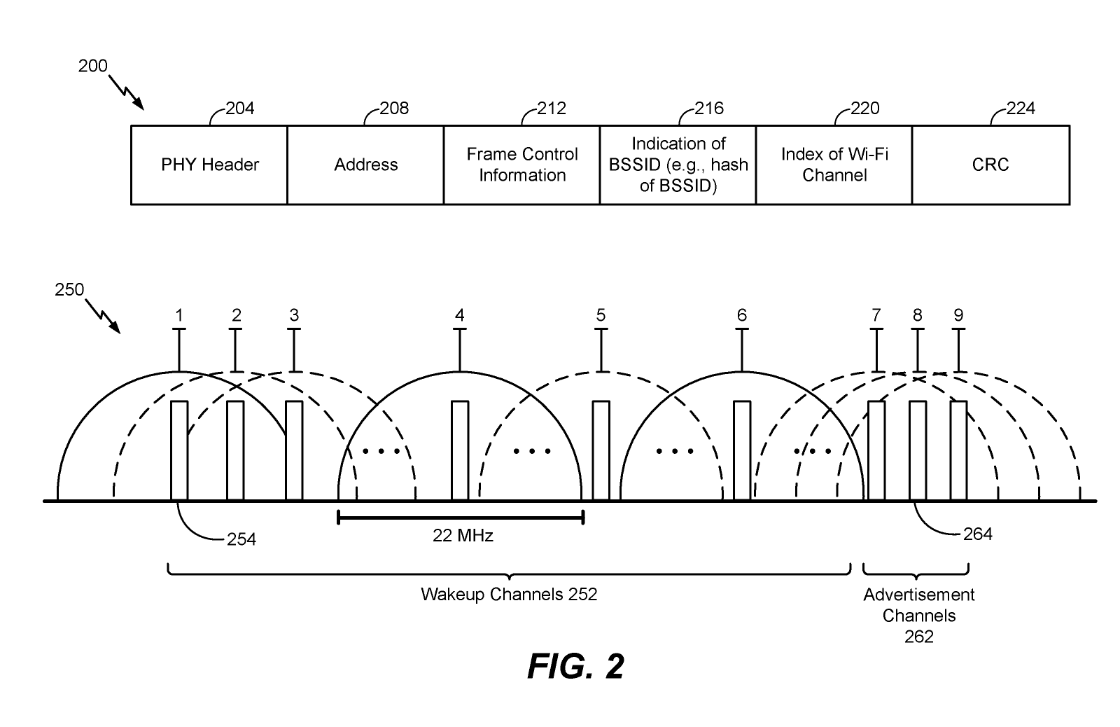

FIG. 2 depicts an illustrative example of a wakeup radio (WUR) frame format 200 that may be associated with the discovery message 116 of FIG. 1. The WUR frame format 200 indicates that the discovery message 116 of FIG. 1 may include one or more of a physical layer (PHY) header 204, an address 208 of the access point 134 of FIG. 1, frame control information 212, an indication 216 of a basic service set identification (BSSID) of the access point 134, an index 220 of a Wi-Fi channel (e.g., the Wi-Fi channel 150) used by the access point 134, or an error detection code, such as a cyclic redundancy check (CRC) 224. In some implementations, the indication 216 includes a “condensed” representation of the BSSID of the access point 134, such as a hash of the BSSID of the access point 134.

Upon receiving the discovery message 116, the wakeup receiver 108 of FIG. 1 may be configured to selectively provide contents of the discovery message 116 to the modem 112 of FIG. 1. For example, the wakeup receiver 108 may be configured to provide the indication 216 of the BSSID and the index 220 of the Wi-Fi channel to the modem 112 to enable association with the access point 134.

FIG. 2 also depicts an example of a channel assignment scheme 250 that may be used by the electronic device 104 and the access point 134 of FIG. 1. The channel assignment scheme 250 indicates wakeup channels 252 and advertisement channels 262. In an illustrative example, the wakeup receiver 108 and the wakeup transmitter 136 of FIG. 1 are configured to communicate using one or more of the wakeup channels 252, one or more of the advertisement channels 262, or a combination thereof.

Each channel of the channel assignment scheme 250 is associated with a corresponding channel number and a corresponding center frequency. For example, the wakeup channels 252 may include a channel 254 associated with a channel number “1” and a center frequency of approximately 2.412 gigahertz (GHz), as an illustrative example. In an illustrative example, the channel 254 is associated with a bandwidth of approximately 22 megahertz (MHz). FIG. 2 illustrates certain other illustrative channels associated with channel numbers 2-9.

FIG. 2 also depicts that the advertisement channels 262 may include a channel 264. In the example of FIG. 2, the advertisement channels 262 are “between” channels of the wakeup channels 252 (e.g., where other wakeup channels 252 are positioned to the right of the advertisement channels 262 in FIG. 2). Positioning the advertisement channels 262 “between” channels of the wakeup channels 252 may reduce interference between messages sent using the wakeup channels 252 and messages sent using the advertisement channels 262.

In some implementations, the channel 140 of FIG. 1 corresponds to one of the advertisement channels 262, such as the channel 264. In this case, the channel 140 may be distinct from the wakeup channels 252, and the channel 140 may be “reserved” or “dedicated” to discovery messages, such as the discovery message 116. In some examples, the channel 140 of FIG. 1 is included in a set of channels that is reserved for discovery messages, such as the discovery message 116. In this example, the access point 134 of FIG. 1 may select the channel 140 from the set of channels using a particular technique (e.g., a round robin technique, randomly, pseudo-randomly, or using another technique).

In another implementation, the channel 140 of FIG. 1 corresponds to one of the wakeup channels 252, such as the channel 254. In this example, the channel 140 may be used for discovery messages (e.g., the discovery message 116) in addition to wakeup messages (e.g., the wakeup message 170).

In connection with an illustrative example of the disclosure, an access point (AP) (e.g., the access point 134) may periodically send advertisements (e.g., the discovery message 116) for discovery by a station (STA) (e.g., the electronic device 104). The advertisements may be sent in WUR frames (e.g., a frame having the WUR frame format 200) at fixed intervals known to the STAs. The advertisements may include a channel index of a Wi-Fi channel (e.g., the Wi-Fi channel 150) of the AP. In an illustrative example, a channel used to communicate the advertisements may be different than a channel indicated by the channel index. To further illustrate, the channel 140 may be used to communicate the advertisements, and the channel index may indicate the Wi-Fi channel 150.

The advertisements may further include a BSSID of the AP or a condensed version of the BSSID, such as a hash of the BSSID. In some implementations, condensing the BSSID may reduce message length of the advertisements. Examples of a condensed BSSID may include hashing a 48-bit BSSID to generate a shorter string, such as an 8-bit string.

The advertisements may be sent using one or more techniques. In a first example, the advertisements may be sent using a common channel used to send other WUR traffic, such as the wakeup message 170. In the first example, the channel 140 may correspond to a WUR channel. In the first example, the WUR channel may be co-located with a Wi-Fi channel (e.g., the channel 140 may be co-located with the Wi-Fi channel 150). Alternatively, the WUR channel may be associated with a different frequency as compared to Wi-Fi channels (e.g., the channel 140 may associated with a different frequency as compared to the Wi-Fi channel 150, such as if each WUR channel is located in a 2.4 GHz band and each Wi-Fi channel is located in a 5 GHz band).

In a second example, the advertisements may be sent using a channel that is distinct from a channel used to send other WUR traffic. In the second example, the channel 140 may correspond to a channel dedicated to the advertisements, such as one of the advertisement channels 262. In the second example, one channel may be allocated for advertisements, or more than one channel may be allocated for advertisements (e.g., as illustrated by the multiple advertisement channels 262 in the channel assignment scheme 250 of FIG. 2). If more than one channel is allocated for advertisements, an AP (e.g., the access point 134) may replicate advertisements on each of the channels to increase robustness. In this case, a STA may not listen on each of the advertisement channels. For example, the electronic device 104 may search using a subset of the advertisement channels 262 (instead of searching all of the advertisement channels 262).

In the example of the channel assignment scheme 250, a relatively small number of advertisement channels 262 are shared by all WURs and are located away from other wakeup channels 252. In this example, the main WUR channels may be co-located with regular Wi-Fi channels.

A WUR in a STA (e.g., wakeup receiver 108 of the electronic device 104) may periodically wake from a sleep mode, listen on one of the channels where advertisements are sent (e.g., the channel 140, one or more of the advertisement channels 262, or a combination thereof), and then switches to the next one of the channels, until all channels where advertisements may be sent are visited. Each STA may choose its own wake-up interval between scans (e.g., by selecting the wakeup schedule 162). A STA may listen on a channel for a duration at least the duration of an advertisement interval of an AP (e.g., for at least the advertising interval 168). During a particular scan by a STA, if no advertisement is received during the scan, the STA may return to the sleep mode until the next scan.

A STA may “filter” received advertisements, such as by determining whether an advertisement matches the selection criterion 124. If an advertisement is received from an AP that the STA does not trust or prefer, then the STA may ignore the advertisement. Alternatively, if the advertisement matches the selection criterion 124, the STA may wake the modem (e.g., the modem 112) and pass the BSSIDs and channel indices of the discovered APs to the modem. The modem may then perform an association procedure with one of the APs. In some implementations, the modem may perform a Wi-Fi scanning procedure in parallel with WUR scanning (e.g., to enable “backward” compatibility with “legacy” APs that may advertise using the Wi-Fi channel 150 instead of the channel 140).

A STA may connect to a Wi-Fi AP using an association procedure, such as an IEEE 802.11 association procedure. During the association procedure, the STA and AP may exchange WUR related parameters, such as the address of the WUR radio of the AP or a random sequence of addresses used by the WUR of the AP. As an illustrative example, the parameters 158 of FIG. 1 may indicate an address or a random sequence of addresses used by the wakeup transmitter 136 of the access point 134. When a STA determines to change from a Wi-Fi active state to a WUR-assisted sleep mode, the STA may signal the AP, such as by sending the request 160. The request may indicate a wakeup schedule of the STA, such as the wakeup schedule 162. The STA may remain active until reception of confirmation (e.g., the confirmation message 166) from the AP, at which time the STA may enter the sleep mode of operation.

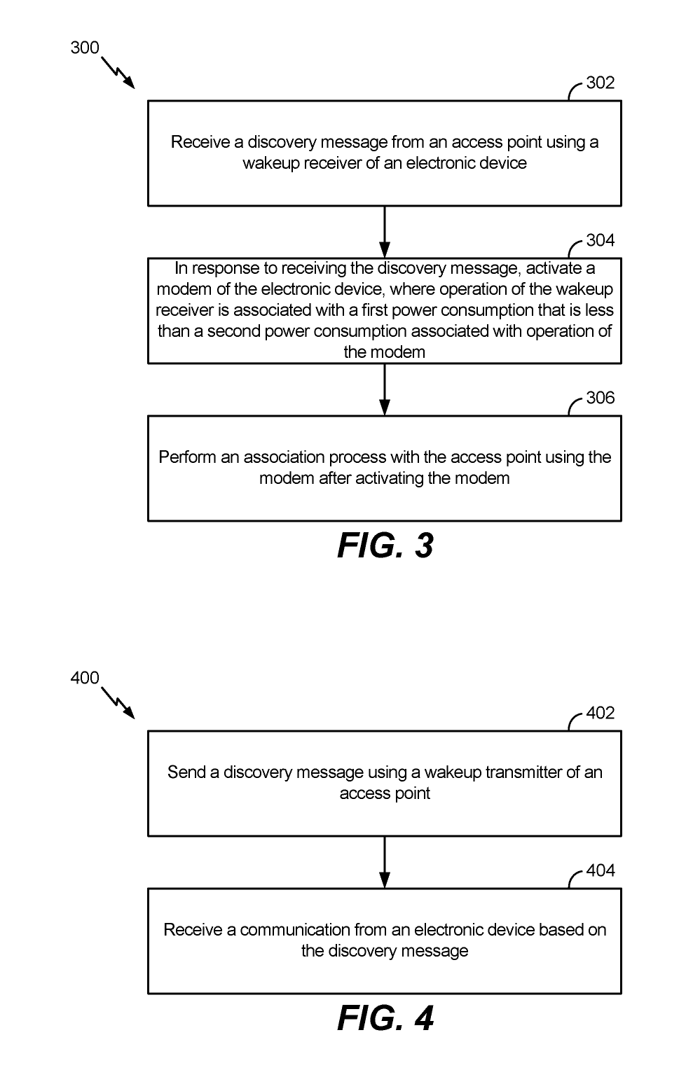

Referring to FIG. 3, an illustrative example of a method of operation of an electronic device is depicted and generally designated 300. In a particular example, the method 300 is performed by the electronic device 104 of FIG. 1.

The method 300 includes receiving a discovery message from an access point using a wakeup receiver of the electronic device, at 302. As an illustrative example, the electronic device 104 may receive the discovery message 116 from the access point 134 using the wakeup receiver 108.

The method 300 further includes activating a modem of the electronic device in response to receiving the discovery message, at 304. Operation of the wakeup receiver is associated with a first power consumption that is less than a second power consumption associated with operation of the modem. As an illustrative example, the electronic device 104 may activate the modem 112 in response to receiving the discovery message 116. In a particular example, the electronic device 104 activates the modem 112 to associate with the access point 134 in response to determining that the access point 134 satisfies the selection criterion 124.

The method 300 further includes performing an association process with the access point using the modem after activating the modem, at 306. As an illustrative example, the electronic device 104 may communicate with the access point 134 by sending the communication 152 to the access point 134, by receiving the parameters 158 from the access point 134, or a combination thereof. Alternatively or in addition, the electronic device 104 may communicate with the access point 134 by sending the request 160 to the access point 134, by receiving the receiving the confirmation message 166 from the access point 134, by performing one or more other operations, or a combination thereof.

Referring to FIG. 4, an illustrative example of a method of operation of an access point is depicted and generally designated 400. In a particular example, the method 400 is performed by the access point 134 of FIG. 1.

The method 400 includes sending a discovery message by the access point using a wakeup transmitter of the access point, at 402. As an illustrative example, the access point 134 may send the discovery message 116 using the wakeup transmitter 136.

The method 400 further includes receiving a communication from an electronic device based on the discovery message, at 404. As an illustrative example, the access point 134 may receive the communication 152 from the electronic device 104 based on the discovery message 116.

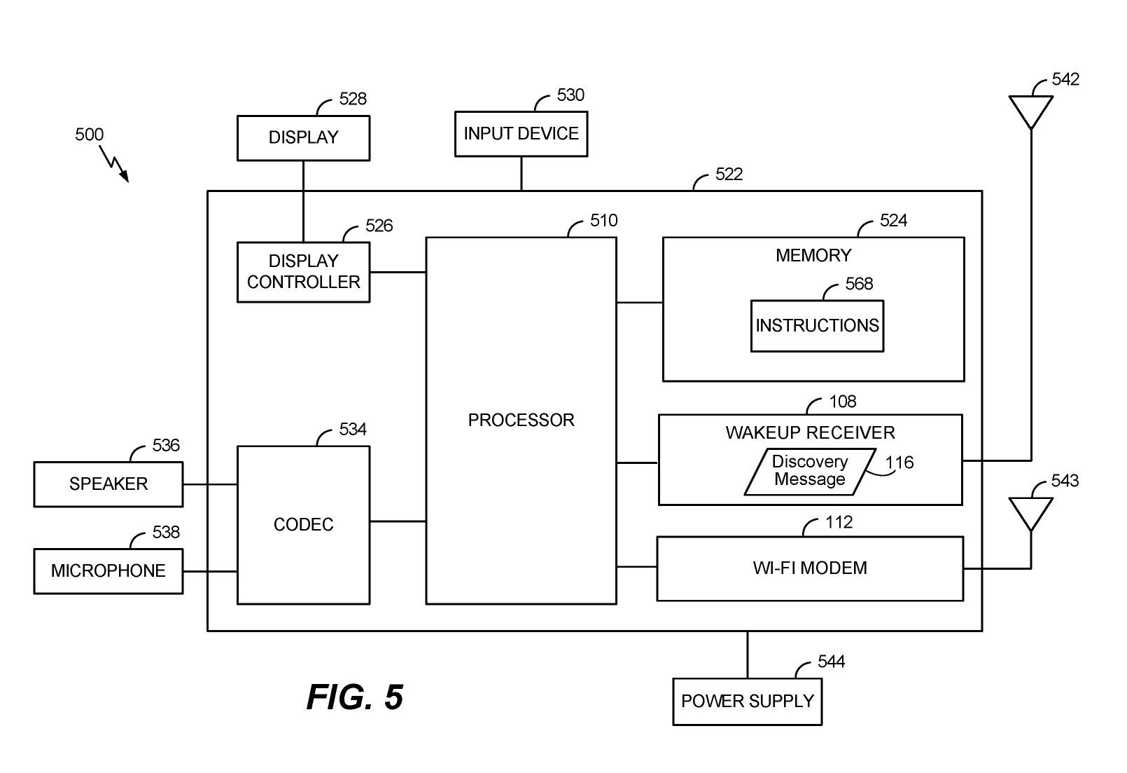

Referring to FIG. 5, a block diagram of a particular illustrative example of an electronic device is depicted and generally designated 500. The electronic device 500 may correspond to a mobile device (e.g., a cellular phone), a computer (e.g., a server, a laptop computer, a tablet computer, or a desktop computer), an access point, an Internet-of-things (IoT) device, a base station, a wearable electronic device (e.g., a personal camera, a head-mounted display, or a watch), a vehicle control system or console, an autonomous vehicle (e.g., a robotic car or a drone), a home appliance, a set top box, an entertainment device, a navigation device, a personal digital assistant (PDA), a television, a monitor, a tuner, a radio (e.g., a satellite radio), a music player (e.g., a digital music player or a portable music player), a video player (e.g., a digital video player, such as a digital video disc (DVD) player or a portable digital video player), a robot, a healthcare device, another electronic device, or a combination thereof.

In some implementations, one or more aspects of the electronic device 500 of FIG. 5 correspond to the electronic device 104 of FIG. 1. Alternatively or in addition, one or more aspects of the electronic device 500 of FIG. 5 may correspond to the access point 134 of FIG. 1.

The electronic device 500 includes one or more processors, such as a processor 510. The processor 510 may include a digital signal processor (DSP), a central processing unit (CPU), a graphics processing unit (GPU), another processing device, or a combination thereof. In a particular example, the processor 510 corresponds to the processor 114 of FIG. 1.

The electronic device 500 further includes one or more memories, such as a memory 524 (e.g., the memory 118 of FIG. 1). The memory 524 may be coupled to the processor 510. The memory 524 may include random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), one or more registers, a hard disk, a removable disk, a compact disc read-only memory (CD-ROM), another memory device, or a combination thereof.

The memory 524 may store instructions 568. The instructions 568 are executable by the processor 510 to perform, initiate, or control one or more operations described herein. In a particular example, the instructions 568 correspond to the instructions 122 of FIG. 1.

A coder/decoder (CODEC) 534 can also be coupled to the processor 510. The CODEC 534 may be coupled to one or more microphones, such as a microphone 538. FIG. 5 also shows a display controller 526 that is coupled to the processor 510 and to a display 528. A speaker 536 may be coupled to the CODEC 534.

The electronic device 500 further includes the wakeup receiver 108 and the modem 112. An antenna 542 may be coupled to the wakeup receiver 108, and an antenna 543 may be coupled to the modem 112. In an alternative implementation, the wakeup receiver 108 and the modem 112 may be coupled to a common antenna.

In a particular example, the processor 510, the memory 524, the display controller 526, the CODEC 534, the wakeup receiver 108, and the modem 112 are included in or attached to a system-on-chip (SoC) device 522. Further, an input device 530 and a power supply 544 may be coupled to the SoC device 522. Moreover, in a particular example, as illustrated in FIG. 5, the display 528, the input device 530, the speaker 536, the microphone 538, the antenna 542, and the power supply 544 are external to the SoC device 522. However, each of the display 528, the input device 530, the speaker 536, the microphone 538, the antenna 542, and the power supply 544 can be coupled to a component of the SoC device 522, such as to an interface or to a controller.

In conjunction with the described embodiments, an apparatus includes means (e.g., the wakeup receiver 108) for receiving a discovery message (e.g., the discovery message 116) from an access point (e.g., the access point 134). The apparatus further includes means (e.g., the control circuitry 110) for generating a wakeup signal (e.g., the wakeup signal 111) based on the discovery message and means (e.g., the modem 112) for performing an association process with the access point in response to the wakeup signal. Operation of the means for receiving the discovery message is associated with a first power consumption that is less than a second power consumption associated with operation of the means for performing the association process.

In conjunction with the described embodiments, a computer-readable medium (e.g., the memory 118 or the memory 524) stores instructions (e.g., the instructions 122 or the instructions 568) executable by a processor (e.g., the processor 114 or the processor 510) to initiate or control operations. The operations include receiving a discovery message (e.g., the discovery message 116) from an access point (e.g., the access point 134) using a wakeup receiver (e.g., the wakeup receiver 108) of an electronic device (e.g., the electronic device 104 or the electronic device 500). The operations further include activating, in response to receiving the discovery message, a modem (e.g., the modem 112) of the electronic device. Operation of the wakeup receiver is associated with a first power consumption that is less than a second power consumption associated with operation of the modem. The operations further include performing an association process with the access point using the modem after activating the modem.

The foregoing disclosed devices and functionalities may be designed and represented using computer files (e.g. RTL, GDSII, GERBER, etc.). The computer files may be stored on computer-readable media. Some or all such files may be provided to fabrication handlers who fabricate devices based on such files. Resulting products include wafers that are then cut into die and packaged into integrated circuits (or “chips”). The chips are then employed in electronic devices, such as the electronic device 104 of FIG. 1, the electronic device 500 of FIG. 5, or both.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc.

The various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

One or more operations of a method or algorithm described herein may be embodied directly in hardware, in a software module executed by a processor, or in a combination of the two. For example, one or more operations of the method 300 of FIG. 3 or the method 400 of FIG. 4 may be initiated, controlled, or performed by a field-programmable gate array (FPGA) device, an application-specific integrated circuit (ASIC), a processing unit such as a central processing unit (CPU), a digital signal processor (DSP), a controller, another hardware device, a firmware device, or a combination thereof. A software module may reside in random access memory (RAM), magnetoresistive random access memory (MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transitory storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed examples is provided to enable a person skilled in the art to make or use the disclosed examples. Various modifications to these examples will be readily apparent to those skilled in the art, and the principles defined herein may be applied to other examples without departing from the scope of the disclosure. Thus, the present disclosure is not intended to be limited to the examples shown herein but is to be accorded the widest scope possible consistent with the principles and novel features as defined by the following claims.

What is claimed is:

1. A method of operation of an electronic device, the method comprising:
receiving a discovery message from an access point using a wakeup receiver of an electronic device;
in response to receiving the discovery message, activating a modem of the electronic device, wherein operation of the wakeup receiver is associated with a first power consumption that is less than a second power consumption associated with operation of the modem; and
performing an association process with the access point using the modem after activating the modem.

2. The method of claim 1, wherein the discovery message includes one or more of a physical layer (PHY) header, an address of the access point, frame control information, an indication of a basic service set identification (BSSID) of the access point, an index of a Wi-Fi channel used by the access point, or an error detection code.

3. The method of claim 2, wherein the error detection code includes a cyclic redundancy check (CRC), and wherein the indication of the BSSID includes a hash of the BSSID.

4. The method of claim 2, further comprising providing the indication of the BSSID and the index of the Wi-Fi channel to the modem to enable association with the access point.

5. The method of claim 1, further comprising identifying, based on the discovery message, a selection criterion.

6. The method of claim 5, wherein the electronic device performs the association process in response to determining based on the discovery message that the access point satisfies the selection criterion.

7. The method of claim 1, wherein performing the association process includes receiving parameters related to a wakeup procedure from the access point.

8. The method of claim 7, wherein the parameters include an identifier indicated by wakeup messages of the access point.

9. The method of claim 1, further comprising sending a request to the access point, the request indicating the electronic device is to enter a sleep mode.

10. The method of claim 9, wherein the request indicates a wakeup schedule of the electronic device.

11. The method of claim 10, further comprising:
receiving a confirmation message from the access point; and
entering the sleep mode in response to the confirmation message.

12. The method of claim 1, further comprising deactivating the modem prior to receiving the discovery message.

13. The method of claim 1, wherein the discovery message has a wakeup radio (WUR) frame format.

14. The method of claim 1, further comprising waking from a sleep mode based on a wakeup schedule to search for the discovery message.

15. The method of claim 14, wherein the electronic device operates based on an active mode for a particular duration of the wakeup schedule to search for the discovery message.

16. The method of claim 15, wherein the particular duration is based on an advertising interval associated with discovery messages.

17. The method of claim 14, further comprising selecting the wakeup schedule by the electronic device.

18. The method of claim 17, wherein the electronic device selects the wakeup schedule to enable a particular power consumption by the electronic device.

19. The method of claim 1, further comprising performing a Wi-Fi scanning process in connection with searching using the wakeup receiver.

20. The method of claim 19, wherein the electronic device performs the Wi-Fi scanning process using a particular search interval that is greater than a wakeup interval associated with searching using the wakeup receiver.

21. An apparatus comprising:
a wakeup receiver configured to receive a discovery message from an access point;
control circuitry coupled to the wakeup receiver, the control circuitry configured to generate a wakeup signal based on the discovery message; and
a modem coupled to the control circuitry, the modem configured to receive the wakeup signal and to perform an association process with the access point in response to the wakeup signal,
wherein operation of the wakeup receiver is associated with a first power consumption that is less than a second power consumption associated with operation of the modem.

22. The apparatus of claim 21, wherein the modem is further configured to communicate with the access point using a Wi-Fi channel, and wherein the wakeup receiver is further configured to receive the discovery message using a channel that is distinct from the Wi-Fi channel.

23. The apparatus of claim 21, further comprising a mobile device that includes the wakeup receiver and the modem.

24. An apparatus comprising:
means for receiving a discovery message from an access point;
means for generating a wakeup signal based on the discovery message; and
means for performing an association process with the access point in response to the wakeup signal,
wherein operation of the means for receiving the discovery message is associated with a first power consumption that is less than a second power consumption associated with operation of the means for performing the association process.

25. The apparatus of claim 24, further comprising a mobile device that includes the means for receiving, the means for generating, and the means for performing.

26. A computer-readable medium storing instructions executable by a processor to initiate or control operations comprising:
receiving a discovery message from an access point using a wakeup receiver of an electronic device;
in response to receiving the discovery message, activating a modem of the electronic device, wherein operation of the wakeup receiver is associated with a first power consumption that is less than a second power consumption associated with operation of the modem; and
performing an association process with the access point using the modem after activating the modem.

27. The computer-readable medium of claim 26, the operations further comprising identifying, based on the discovery message, a selection criterion.

28. The computer-readable medium of claim 27, wherein the electronic device performs the association process in response to determining based on the discovery message that the access point satisfies the selection criterion.

29. The computer-readable medium of claim 26, the operations further comprising deactivating the modem prior to receiving the discovery message.

30. The computer-readable medium of claim 26, wherein the discovery message has a wakeup radio (WUR) frame format.
